(19) United States
(12) Patent Application Publication
(10) Pub. No.: US 2025/0360834 A1
(43) Pub. Date: Nov. 27, 2025

(54) BATTERY CHARGING GUIDANCE METHODS AND SYSTEMS FOR DIFFERENT TYPES OF BATTERIES IN ELECTRIC VEHICLES

(71) Applicants: Hyundai Motor Company, Seoul (KR); Kia Corporation, Seoul (KR)

(72) Inventor: Hye Joo Lee, Hwaseong-si (KR)

(21) Appl. No.: 18/951,014

(22) Filed: Nov. 18, 2024

(30) Foreign Application Priority Data
May 22, 2024 (KR) 10-2024-0066474

(51) Int. Cl. B60L 58/13; B60L 53/30; B60L 58/14

(52) U.S. Cl. CPC B60L 58/13; B60L 53/305; B60L 58/14

(57) ABSTRACT

A battery charging guidance method can include determining a type of a battery installed in a vehicle, monitoring a charging state of the battery, and when the battery is determined to be a lithium iron phosphate (LFP) type and the charging state of the battery enters an unreliable state of charge (SOC), setting a charging target amount of the battery to full charge, and deactivating a charging target amount setting function of a user in a vehicle app included in a head unit of the vehicle and/or in a user terminal app included in a user terminal.

### CROSS-REFERENCE TO RELATED APPLICATIONS

This application claims the priority and benefit of Korean Patent Application No. 10-2024-0066474, filed on May 22, 2024, which application is hereby incorporated herein by reference.

### TECHNICAL FIELD

The present disclosure relates to battery charging guidance methods and systems for electric vehicles.

### BACKGROUND

Recently, as electric vehicles, vehicles powered by electricity, have become popular, the types and capacities of batteries installed in electric vehicles have also diversified. For certain types of batteries, battery performance, including charging speed and the like, may deteriorate depending on the driver's battery charging pattern.

In detail, in the case of LFP batteries having lithium iron phosphate (LiFePO4) as a raw material, compared to other types of batteries, such as NCM batteries having nickel cobalt manganese, when charging/discharging cycles are repeated, charging performance may deteriorate rapidly at a certain point if 100% charging is not periodically obtained. Therefore, there is a demand for technology that may resolve this problem.

### SUMMARY

The present disclosure relates to battery charging guidance methods and systems according to the types of batteries in electric vehicles.

An embodiment of the present disclosure can maintain battery performance by encouraging a driver to charge a battery at an appropriate time when the battery requires periodic charging depending on a type of battery.

An embodiment of the present disclosure can increase driver convenience or freedom by flexibly providing information to the driver that the battery needs to be fully charged depending on the condition of a vehicle and the type and condition of the battery.

According to an embodiment of the present disclosure, a battery charging guidance method and system according to the type of a battery in electric vehicles through various embodiments can be provided.

According to an embodiment of the present disclosure, a battery charging guidance method can include: determining a type of a battery installed in a vehicle; monitoring a charging state of the battery; and when the battery is determined to be a lithium iron phosphate (LFP) battery and the charging state of the battery enters an unreliable state of charge (SOC), setting a charging target amount of the battery to full charge, and deactivating a charging target amount setting function of a user in at least one of a vehicle app included in a head unit of the vehicle and a user terminal app included in a user terminal.

When a charge/discharge cycle is repeated ten or more times in succession while the battery is not fully charged, it may be determined that the unreliable SOC has been entered.

The battery charging guidance method may further include outputting a message informing that charging target amount setting cannot be changed on at least one of an output unit included in the head unit and the user terminal app, when a user's attempt to change the charging target amount setting is detected, after the deactivating.

The battery charging guidance method may further include reactivating the charging target amount setting function in at least one of the vehicle app and the user terminal app, when the charging state of the battery is not in the unreliable SOC, after the deactivating.

When the battery of the vehicle is fully charged at least once, it may be determined to be not in or no longer in the unreliable SOC.

After the monitoring and before entering the unreliable SOC, when a charge/discharge cycle is repeated five or more times in succession while the battery is not fully charged, a first preliminary alarm may be output to at least one of an output unit included in the vehicle, the user terminal app, and a cluster included in the vehicle.

When the charge/discharge cycle is repeated eight or more times in succession while the battery is not fully charged, a second preliminary alarm may be output to at least one of the output unit, the user terminal app, and the cluster.

When the battery of the vehicle is determined to be a type of battery other than the LFP battery, a preset function may be performed in the vehicle app and the user terminal app, respectively, without outputting a separate alarm.

According to an embodiment of the present disclosure, a battery charging guidance system can include: a battery management unit configured to determine a type of a battery installed in a vehicle and monitor a charging state of the battery; a head unit connected to the battery management unit and including a processor, a communication unit, an output unit, and a vehicle app; a server communicating with the communication unit; and a user terminal app communicating with the server. When the battery management unit determines that the battery is an LFP battery and the charging state is in an unreliable state of charge (SOC), the processor can fix a charging target amount of the battery to full charge and disable a charging target amount setting function of a user in at least one of the vehicle app and the user terminal app.

The battery management unit may determine that the battery has entered the unreliable SOC when a charge/discharge cycle is repeated ten or more times in succession while the battery is not fully charged.

When an attempt of the user to change charging target amount setting is detected after the charging target amount setting function is deactivated, the processor may output a message informing that the charging target amount setting cannot be changed on at least one of the output unit and the user terminal app.

The processor may reactivate the charging target amount setting function in at least one of the vehicle app and the user terminal app when the charging state of the battery is not in the unreliable SOC after the charging target amount setting function is deactivated.

It may be determined that the vehicle is not in or no longer in the unreliable SOC when the battery is fully charged at least once.

The processor may output a first preliminary alarm to at least one of the output unit, the user terminal app, and a cluster included in the vehicle when a charge/discharge cycle is repeated five or more times in succession while the battery is not fully charged.

The processor may output a second preliminary alarm to at least one of the output unit, the user terminal app, and the cluster when the charge/discharge cycle is repeated eight or more times in succession while the battery is not fully charged.

The processor may perform a preset function in the vehicle app and the user terminal app, respectively, without outputting a separate alarm, when the battery management unit determines that the battery of the vehicle is a type of battery other than the LFP battery.

### BRIEF DESCRIPTION OF THE DRAWINGS

The above and other features and advantages of embodiments of the present disclosure can be more clearly understood from the following detailed description, taken in conjunction with the accompanying drawings, in which:

FIG. 1 is a conceptual diagram schematically illustrating a battery charging guidance system according to an embodiment of the present disclosure;

FIG. 2 is a diagram illustrating a signal flow in FIG. 1 in more detail, according to an embodiment of the present disclosure;

FIG. 3 is a diagram illustrating a detailed configuration of a head unit of FIG. 2, according to an embodiment of the present disclosure;

FIG. 4 is a diagram illustrating a detailed configuration of a battery management unit and a cluster of FIG. 2, according to an embodiment of the present disclosure;

FIG. 5 is a flowchart of a battery charging guidance method according to an embodiment of the present disclosure;

FIG. 6 is a diagram illustrating illustrative text of a preliminary alarm and setting change-impossible indication of FIG. 5, according to an embodiment of the present disclosure;

FIG. 7 is a sequence diagram when a battery management unit recognizes a battery installed in a vehicle as an NCM battery, according to an embodiment of the present disclosure;

FIG. 8 is a sequence diagram when a battery management unit recognizes a battery installed in a vehicle as an LFP battery and when not entering an unreliable SOC, according to an embodiment of the present disclosure;

FIG. 9 is a sequence diagram when entering an unreliable SOC after the operation of FIG. 8, according to an embodiment of the present disclosure; and

FIG. 10 is a sequence diagram for a case of deviating from the unreliable SOC after the operation of FIG. 9, according to an embodiment of the present disclosure.

### DETAILED DESCRIPTION OF ILLUSTRATIVE EMBODIMENTS

Specific example embodiments will be illustrated in the drawings and described in detail, and various changes thereof can provide various other embodiments of the present disclosure. The present disclosure is not intended to be necessarily limited by the specific example embodiments, and can be understood to include all changes, equivalents, and substitutes included in the spirit and technical scopes of the present disclosure.

Terms such as “first,” “second,” and the like, may be used to describe various components, but the components are not necessarily limited by such terms. Such terms can be used merely for distinguishing one component from another. For example, a first component may be referred to as a second component without departing from the scopes of the present disclosure, and similarly, the second component may also be referred to as a first component. The term ‘and/or’ can include any combination of a plurality of related stated items or any of a plurality of related stated items.

The terms used in this specification are used to describe specific example embodiments and are not intended to necessarily limit the present disclosure. Singular expressions include plural expressions unless the context clearly dictates otherwise. In this specification, terms such as “include” or “have” are intended to designate the presence of features, numbers, steps, operations, components, parts, or combinations thereof described in the specification. Therefore, it can be understood that this does not exclude in advance the presence or addition of one or more other features, numbers, steps, operations, components, parts or combinations thereof.

Unless otherwise defined, terms used herein, including technical or scientific terms, can have a same meaning as generally understood by a person of ordinary skill in the technical field to which the present disclosure pertains. Terms defined in commonly used dictionaries can be interpreted as having a meaning consistent with the meaning in the context of the related technology.

In this specification, a vehicle can refer to a variety of vehicles that move transported objects, such as people, animals, or goods, from a starting point to a destination. These vehicles are not necessarily limited to vehicles traveling on roads or tracks.

In various embodiments of the present disclosure, if the battery included in the electric vehicle is a lithium iron phosphate (LFP) battery, e.g., made of lithium iron phosphate (Li—FePO4), a preliminary alarm can be output to guide the user to fully charge the battery according to the charging state of the battery. When the battery enters an unreliable State Of Charge (SOC), the charging target amount can be fixed at full charge, for example, 100%, and the user's setting change function can be disabled. And unreliable SOC can be a situation in which there has been an unreliable state of charge (SOC) for charging to full capacity for an LFP battery, for example. Deterioration of battery performance, such as charging speed, may be prevented through periodic full charging of the LFP battery.

Hereinafter, example embodiments will be described in more detail with reference to the attached drawings.

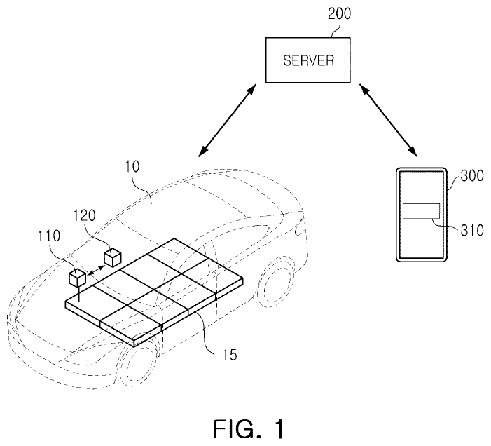

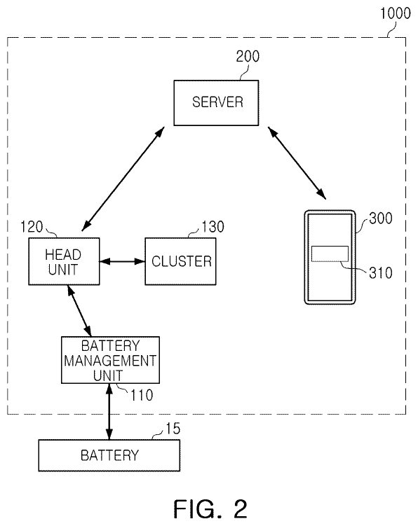

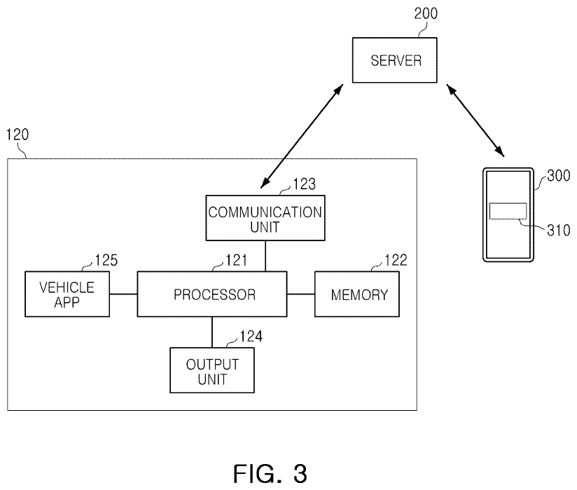

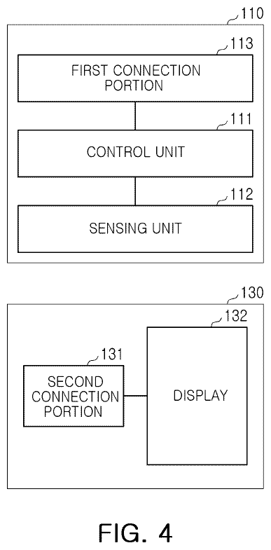

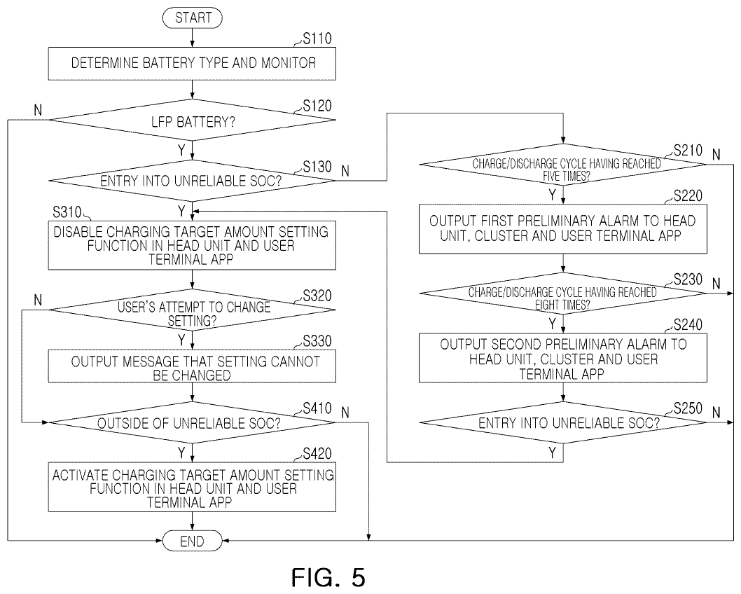

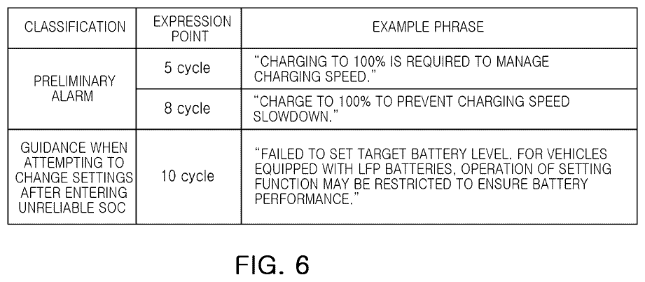

FIG. 1 is a conceptual diagram schematically illustrating a battery charging guidance system according to an embodiment of the present disclosure. FIG. 2 is a diagram illustrating the signal flow in FIG. 1 in more detail, according to an embodiment of the present disclosure. FIG. 3 is a diagram illustrating the detailed configuration of the head unit of FIG. 2, according to an embodiment of the present disclosure. FIG. 4 is a diagram illustrating the detailed configuration of the battery management unit and cluster of FIG. 2, according to an embodiment of the present disclosure. FIG. 5 is a flowchart of a battery charging guidance method according to an embodiment of the present disclosure. FIG. 6 is a diagram illustrating example text of the preliminary alarm and setting change not possible guidance display of FIG. 5, according to an embodiment of the present disclosure.

Referring to FIGS. 1 and 2, the battery charging guidance system 1000 according to an embodiment may include a battery management unit 110 connected to a battery 15 mounted on an electric vehicle 10, a head unit 120 connected to the battery management unit 110, a server 200 that communicates with the head unit 120 to transmit, receive, and store data, and an app 310 for user terminal included in a user terminal 300, any of, any combination of, or all of which may be in plural or may include plural components thereof.

The battery management unit 110 may correspond to a battery management system (BMS) and may recognize and determine the type of battery 15 installed in the vehicle 10. As an example, the battery management unit 110 may determine whether the battery 15 mounted on the vehicle 10 corresponds to an NCM battery containing nickel (Ni), cobalt (Co), and manganese (Mn), or an LFP battery containing lithium iron phosphate (LiFePO₄). However, the present disclosure is not necessarily limited thereto, and the battery management unit 110 may recognize and determine the type even if the battery 15 mounted on the vehicle 10 is of a type other than an NCM battery or an LFP battery.

The battery management unit 110 may monitor the state of the battery 15. As an example, the battery management unit 110 may monitor voltage, current, temperature, state of charge (SOC), lifespan or State of Health (SOH), and number of charge/discharge times of each cell of the battery 15 and the entire battery pack, or the like.

Referring to FIGS. 2 and 4, the battery management unit 110 may include a control unit 111, a sensing unit 112, and a first connection unit 113, any of, any combination of, or all of which may be in plural or may include plural components thereof. The control unit 11 can control the sensing unit 112 connected to the battery 15 to determine the type of the battery 15 and monitor the state of the battery 15. Data on the type of battery 15 determined by the battery management unit 110 and data on monitoring the status of the battery 15 may be transmitted to the head unit 120 connected through the first connection unit 113.

Referring to FIGS. 2 and 3, the head unit 120 can be connected to the battery management unit 110 and may receive data about the type of battery 15 and data about monitoring the status of the battery 15, and may include a processor 121, a communication unit 123, an output unit 124, and a vehicle app 125, any of, any combination of, or all of which may be in plural or may include plural components thereof. The head unit 120 may further include a memory 122 capable of storing data, and the memory 122 may be in plural or may include plural components thereof.

The processor 121 can be connected to the memory 122, the communication unit 123, the output unit 124, and the vehicle app 125, respectively, and may control these configurations. For example, the processor 121 in an embodiment may correspond to a microcontroller, and may control the head unit 120 through transmission and reception of Controller Area Network (CAN) signals containing various information regarding the vehicle 10, including information regarding the battery 15.

When the processor 121 determines by the battery management unit 110 that the battery 15 mounted on the vehicle 10 is an LFP battery and the charging state is in the unreliable SOC, and the charging target amount of the battery 15 may be fixed to full charge, for example, 100%, and the user's charging target amount setting function may be disabled in at least one of the vehicle app 125 and the user terminal app 310.

The unreliable SOC can refer to a section in which the accuracy of the battery management unit's prediction of the state of the battery 15 is significantly reduced. For example, if the charge/discharge cycle is repeated ten or more times in succession while the LFP battery is not fully charged, it may be determined that the battery 15 has entered the unreliable SOC, but the present disclosure is not necessarily limited thereto.

When the processor 121 detects a user's attempt to change the charging target amount setting after the charging target amount setting function is deactivated, at least one of the output unit 124 of the head unit 120 and the user terminal app 310 may output a message informing that charging target amount settings cannot be changed. In such situation, the output unit 124 may correspond to a display included in the head unit 120, and referring to FIG. 6, the message indicating that the charge target amount setting cannot be changed may be a message such as “Failed to set target battery level. For vehicles equipped with LFP batteries, operation of setting function may be restricted to ensure battery performance.”, but the present disclosure is not necessarily limited thereto.

In addition, when the battery management unit 110 recognizes that the charging state of the battery 15 is no longer in the unreliable SOC after the charging target amount setting function is deactivated, the processor 121 may reactivate the charging target amount setting function in at least one of the vehicle app 125 and the user terminal app 310.

The battery management unit 110 may determine that the vehicle 10 is no longer in the unreliable SOC when the battery 15 is fully charged at least once. For example, if the battery 15 mounted on the vehicle 10 is an LPF battery, if the charge/discharge cycle is repeated ten or more times in succession without full charging, the processor 121 may determine that the battery 15 has entered the unreliable SOC, and afterwards, if the battery 15 is fully charged at least once, the processor 121 may determine that the battery 15 is not in the unreliable SOC.

If the charge/discharge cycle is repeated five or more times in a row while the battery 15 is not fully charged, the processor 121 may output the first preliminary alarm to at least one of the output unit 124, the user terminal app 310, and the cluster 130 included in the vehicle 10. Referring to FIG. 6, the first preliminary alarm may include a message such as “Charging to 100% is required to manage charging speed,” but the present disclosure is not necessarily limited thereto. This first preliminary alarm may prevent performance degradation, such as the charging speed of the battery 15, by inducing the user to fully charge the battery 15 in advance before entering the unreliable SOC.

The cluster 130 may be located in the direction of the steering wheel of the vehicle 10 and display key information about the vehicle 10. Referring to FIGS. 2 and 4, the cluster 130 may include a second connection portion 131 and a display 132, either or both of which may be in plural or may include plural components thereof. The cluster 130 can be connected to the head unit 120 through the second connection portion 131, and may display information transmitted from the processor 121 of the head unit 120 on the display 132.

As an example, the cluster 130 may include, but is not necessarily limited to, a cluster display disposed on the dashboard of the vehicle 10 to display an image, and/or a head-up display that projects an image onto the windscreen.

If the charge/discharge cycle is repeated eight or more times in a row while the battery 15 is not fully charged, the processor 121 may output the second preliminary alarm to at least one of the output unit 124, the user terminal app 310, and the cluster 130 included in the vehicle 10. Referring to FIG. 6, the second preliminary alarm may include a message such as “Charge to 100% to prevent charging speed slowdown,” but the present disclosure is not necessarily limited thereto. This second preliminary alarm may prevent performance degradation, such as the charging speed of the battery 15, by inducing the user to fully charge the battery 15 before entering the unreliable SOC.

If the battery management unit 110 determines that the battery 15 of the vehicle 10 is a type other than an LFP battery, the processor 121 may perform preset functions in each of the vehicle app 125 and the user terminal app 310 without outputting a separate alarm. For example, if the battery 15 of the vehicle 10 is a type other than an LFP battery, it may be an NCM battery, and in such case, periodic buffering can be unnecessary, and thus, the processor 121 may perform preset functions such as a target charge amount setting function or a battery 15 management function in each of the vehicle app 125 and the user terminal app 310 without outputting a preliminary alarm for full charge.

In an embodiment, the processor 121 may be a central processing unit (CPU) or a semiconductor device that processes instructions stored in the memory 122. The operations of the method or algorithm described in connection with example embodiments of the present disclosure may be implemented directly in hardware or software modules executed by processor 121, or a combination of the two. Software modules may reside in a storage medium such as RAM memory, flash memory, ROM memory, EPROM memory, EEPROM memory, registers, hard disk, solid state drive (SSD), removable disk, or CD-ROM. By way of example, a storage medium can be coupled to a processor 121 that may read information from and write information to the storage medium. Alternatively, the storage medium may be integrated with the processor 121. Processor 121 and storage media may reside within an application specific integrated circuit (ASIC). The ASIC may reside within the user terminal. Alternatively, processor 121 and storage media may reside as separate components within the user terminal.

Referring to FIG. 3, the memory 122 can be connected to the processor 121 and can be controlled by the processor 121, and may store data on the type of battery 15 determined by the battery management unit 110, data on the status of the battery 15 monitored by the battery management unit 110, and the like.

The memory 122 may include, but is not limited to, at least one type of storage medium among memories such as flash memory type, hard disk type, micro type, and card type (for example, Secure Digital Card (SD Card) or eXtream Digital Card (XD Card)) and memories such as a Random Access Memory (RAM), a Static RAM (SRAM), a Read-Only Memory (ROM), a Programmable ROM (PROM), an Electrically Erasable PROM (EEPROM), a magnetic memory (Magnetic RAM (MRAM)), a magnetic disk, or an optical disk type memory, or any combination thereof.

The communication unit 123 can be a component included in the head unit 120, can be controlled by the processor 121, and may transmit and receive data with the server 200. The communication unit 123 may obtain status information of the vehicle 10 or the battery 15 from various sensors or the battery management unit 110, and transmit the control signal of the processor 121 based on the acquired data to the server 200.

For example, the communication unit 123 may be configured to perform vehicle network communication such as Controller Area Network (CAN) communication, Local Interconnect Network (LIN) communication, and/or Flex-ray communication, but the present disclosure is not necessarily limited thereto.

The output unit 124 can be a component included in the head unit 120 and can be controlled by the processor 121, and depending on the condition of the battery 15, may output a first preliminary alarm, a second preliminary alarm, and a message indicating that charging target amount settings cannot be changed.

The output unit 124 may include, for example, a Liquid Crystal Display (LCD) panel or an Organic Light Emitting Diode (OLED) panel, but the present disclosure is not necessarily limited thereto.

The vehicle app 125 can be a component included in the head unit 120, can be controlled by the processor 121, and may set the target charging amount of the battery 15 of the vehicle 10 according to the user's settings. For example, the vehicle app 125 may be set so that the battery 15 is not fully charged according to the user's settings, and may be set to allow charging only up to the section where rapid charging is possible, but the present disclosure is not necessarily limited thereto.

When the battery 15 of the vehicle 10 enters the unreliable SOC, the battery charging target amount setting function in the vehicle app 125 may be disabled by the processor 121.

Referring to FIGS. 1 to 3, the server 200 may transmit a control signal of the head unit 120 from the vehicle 10 to the user terminal 300 through a wireless network or the like.

In more detail, the server 200 may transmit and receive data with the communication unit 123 included in the head unit 120, and transmit a control signal of the processor 121 included in the head unit 120 to the user terminal app 310 included in the user terminal 300. Also, conversely, the information entered by the user may be transmitted to the head unit 120 of the vehicle 10 through the user terminal app 310.

The server 200 in an embodiment may correspond to a Connected Car Service (CCS) server or an external server, but the present disclosure is not necessarily limited thereto.

The user terminal 300 may correspond to a smart device such as a user's smartphone or tablet, and may include at least one app 310 for the user terminal. The user terminal app 310 may display various information about the battery 15 of the vehicle 10 and include a setting function such as a battery charging target amount.

When the battery 15 of the vehicle 10 enters the unreliable SOC, the battery charging target amount setting function in the user terminal app 310 may be disabled by the processor 121.

FIG. 5 is a flowchart of a battery charging guidance method according to an embodiment of the present disclosure.

Referring to FIG. 5, the battery management unit 110 may first determine the type of battery 15 mounted on the vehicle 10 and monitor the state of the battery 15 (operation S110). In this example, the type of battery 15 may be either an LFP battery or an NCM battery, but the present disclosure is not limited thereto and other types of batteries may also be included. The status of the monitored battery 15 may include factors such as voltage, current, temperature, state of charge (SOC), lifespan (state of health, SOH), or number of charge/discharge times of each cell of the battery 15 and the entire battery pack, or any combination thereof, for example.

Next, when the battery management unit 110 determines that the battery 15 mounted on the vehicle 10 is an LFP battery (operation S120), it may be determined whether the battery 15 has entered an unreliable SOC based on the battery 15 status monitoring information (operation S130). The battery management unit 110 may determine that the battery 15 has entered an unreliable SOC when the charge/discharge cycle is repeated ten or more times in succession while the battery 15 is not fully charged, for example.

When the battery management unit 110 determines that the battery 15 mounted on the vehicle 10 is a battery other than an LFP battery, for example, an NCM battery, the battery management unit 110 may perform preset functions in each of the vehicle app 125 and the user terminal app 310 without separate alarm output.

If the battery 15 does not enter the unreliable SOC, the processor 121 may check through the battery management unit 110 whether the charge/discharge cycle has been repeated five or more times in succession while the battery 15 of the vehicle 10 is not fully charged (operation S210), and when repeated five or more times, the processor 121 may output a first preliminary alarm to at least one of the output unit 124 of the head unit 120, the cluster 130, and the user terminal app 310 (operation S220). Referring to FIG. 6, the first preliminary alarm may be, but is not limited to, a message such as “Charging to 100% is required to manage charging rate.”

Next, the processor 121 may check through the battery management unit 110 whether the charge/discharge cycle has been repeated eight or more times in succession while the battery 15 of the vehicle 10 is not fully charged (operation S230), and when repeated eight or more times, the processor 121 may output a second preliminary alarm to at least one of the output unit 124 of the head unit 120, the cluster 130, and the user terminal app 310 (operation S240). Referring to FIG. 6, the second preliminary alarm may be, but is not limited to, a message such as “Charge to 100% to prevent charging slowdown.”

Next, the processor 121 may check through the battery management unit 110 whether the charge/discharge cycle has been repeated ten or more times in succession while the battery 15 of the vehicle 10 is not fully charged for example (operation S250), and when if repeated ten or more times, the battery management unit 110 may determine that the battery 15 has entered the unreliable SOC.

In this manner, if it is determined that the battery 15 has entered the unreliable SOC, the processor 121 may set the charging target amount of the battery 15 of the vehicle 10 to full charge, for example, 100%, and may disable the user's charging target amount setting function in at least one of the vehicle app 125 and the user terminal app 310 (operation S310).

If the user's attempt to change the charging target amount setting is detected after the charging target amount setting function is disabled (operation S320), the processor 121 may output a message informing that the charge target amount setting cannot be changed in at least one of the output unit 124 of the head unit 120 and the user terminal app 310 (operation S330). In such situation, the output unit 124 may correspond to a display included in the head unit 120, and referring to FIG. 6, the message indicating that the charge target amount setting cannot be changed may be, but is not limited to, a message such as “Failed to set target battery level. For vehicles equipped with LFP batteries, operation of setting function may be restricted to ensure battery performance.”

Next, if the battery management unit 110 recognizes that the charging state of the battery 15 is not in the unreliable SOC after the operation in which the charging target amount setting function is deactivated (operation S410), the processor 121 may reactivate the charging target amount setting function in at least one of the vehicle app 125 and the user terminal app 310 (operation S420).

For operation S410, the battery management unit 110 may determine that the vehicle 10 is no longer in the unreliable SOC when the battery 15 is fully charged at least once. For example, when the battery 15 mounted on the vehicle 10 is an LPF battery and the charge/discharge cycle is repeated ten or more times in succession without full charging, it may be determined that the battery has entered the unreliable SOC, and afterwards, when the battery 15 is fully charged at least once, it may be determined that the battery is no longer in the unreliable SOC. Thereafter, the user may freely set the charging target amount of the battery 15 through the vehicle app 125 and/or the user terminal app 310.

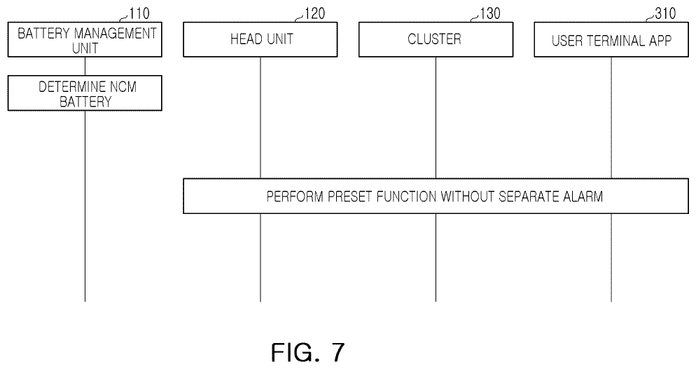

FIGS. 7 to 10 show sequence diagrams of various situations depending on the type and state of the vehicle battery, according to example embodiments of the present disclosure.

FIG. 7 is a sequence diagram when the battery management unit recognizes the battery installed in the vehicle as an NCM battery.

Referring to FIG. 7, when the battery management unit 110 determines that the battery 15 of the vehicle 10 is an NCM battery, each of the head unit 120, cluster 130, and user terminal app 310 may perform a preset function without outputting a separate alarm.

When the battery 15 of the vehicle 10 is an NCM battery, because battery performance, such as charging speed, typically does not deteriorate even if there is no periodic charging, without output such as preliminary alarm for full charge, the head unit 120, cluster 130, and user terminal app 310 may each perform preset functions such as a target charge amount setting function, battery 15 management function, or general guide text output without a separate alarm output.

The NCM battery is an example of a case where the battery 15 of the vehicle 10 is not an LFP battery, and is not limited thereto, and may have the same sequence even when batteries other than NCM and LFP batteries are installed.

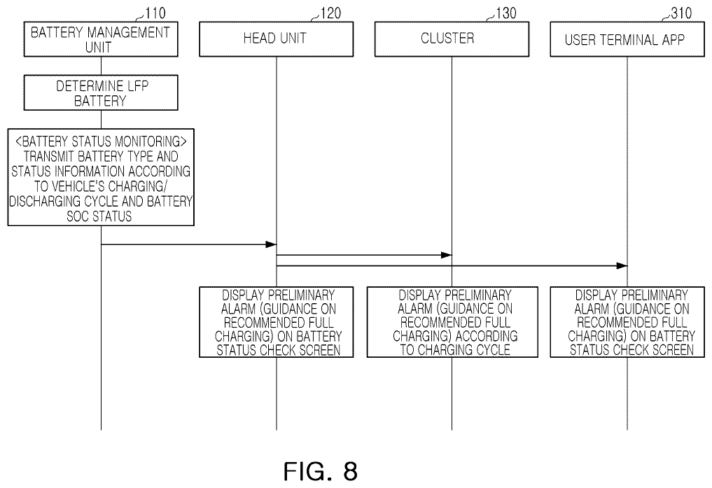

FIG. 8 is a sequence diagram when the battery management unit determines that the battery installed in the vehicle is an LFP battery and the battery does not enter the unreliable SOC.

Referring to FIG. 8, when the battery management unit 110 determines that the battery 15 of the vehicle 10 is an LFP battery, the battery management unit 110 may monitor the state of the battery 15 and transmit the type and state of charge information of the battery 15 to the head unit 120 according to the charge/discharge cycle and state of charge (SOC).

Based on the information acquired through the battery management unit 110, the head unit 120 may output a preliminary alarm when the type of battery 15 is an LFP battery and the number of charge/discharge cycles without being fully charged reaches a standard number. In addition, the reference number of times may be set to a plurality of times, such as a first reference number and a second reference number. For example, the first reference number may be five times and the second reference number may be eight times, but are not necessarily limited thereto.

In addition, the head unit 120 may transmit control commands to the cluster 130 and the user terminal app 310 and control a preliminary alarm to be output in each configuration. The preliminary alarm may be a message that recommends the user to fully charge the battery 15. Therefore, the user may recognize that the battery 15 needs to be fully charged before the performance of the battery 15, such as charging speed, deteriorates.

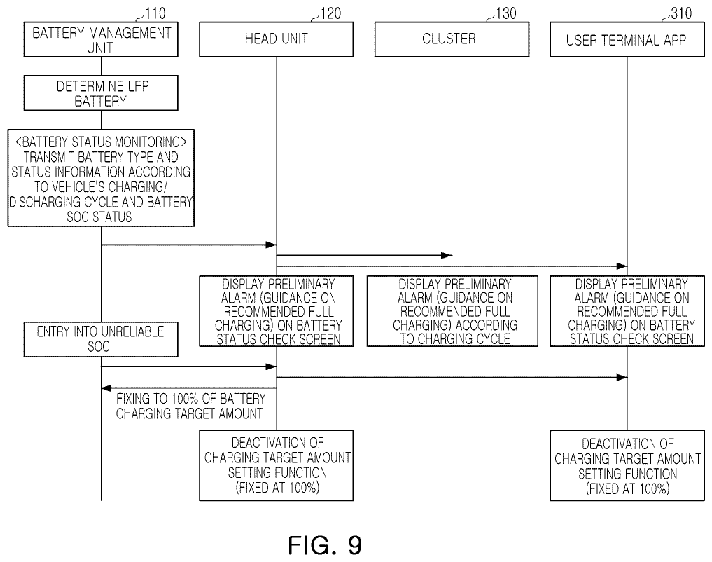

FIG. 9 is a sequence diagram when the battery enters the unreliable SOC after the step of FIG. 8.

Referring to FIG. 9, when the battery management unit 110 monitors the state of the battery 15 and determines that it has entered an unreliable SOC, the head unit 120 may control the battery management unit 110 to fix the charging target amount of the battery 15 at 100% and disable the battery charging target amount setting function of the vehicle app 125 included in the head unit 120.

The head unit 120 may transmit a control command to the user terminal app 310 to disable the battery charging target amount setting function of the user terminal app 310.

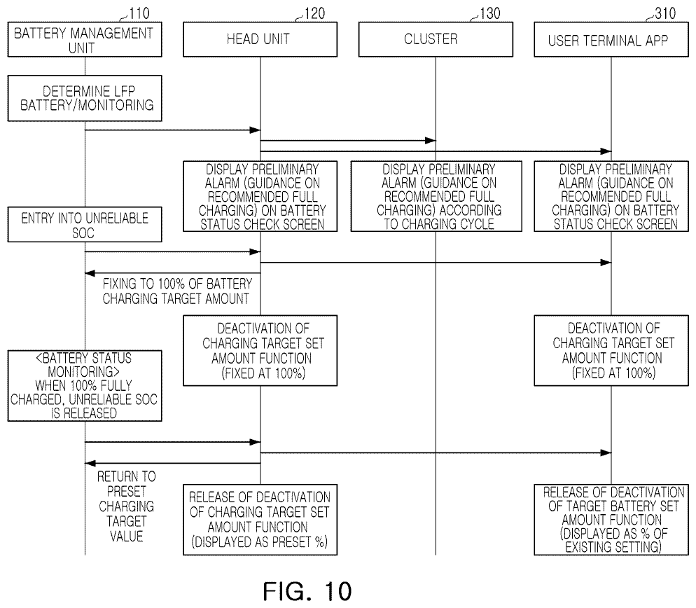

FIG. 10 is a sequence diagram when the battery deviates from the unreliable SOC after the operation of FIG. 9.

Referring to FIG. 10, if the battery 15 is fully charged at least once after entering the unreliable SOC, the battery management unit 110 may determine that the battery 15 is out of the unreliable SOC.

If the battery 15 is not in the unreliable SOC, the head unit 120 may return the charging target amount of the battery management unit 110 to the value previously set before setting it to 100%, and reactivate battery charging target amount setting function of the car app 125 included in the head unit 120.

The head unit 120 may reactivate the battery charging target amount setting function of the user terminal app 310 by transmitting a control command to the user terminal app 310.

As set forth above, according to some example embodiments, battery performance may be maintained by encouraging a driver to charge a battery at an appropriate time when the battery requires periodic charging depending on a type of battery.

According to some example embodiments, driver convenience or freedom may be increased by flexibly providing information to the driver that the battery needs to be fully charged depending on the condition of a vehicle and the type and condition of the battery.

While example embodiments have been shown and described above, it can be apparent to those skilled in the art that modifications and variations can be made without departing from the scopes of the present disclosure as defined by the appended claims.

What is claimed is:

1. A battery charging guidance method comprising:
determining a type of a battery installed in a vehicle;
monitoring a charging state of the battery; and
in response to the type of the battery being determined to be a lithium iron phosphate (LFP) type and the charging state of the battery entering an unreliable state of charge (SOC), setting a charging target amount of the battery to full charge, and deactivating a charging target amount setting function of a user in both of or one of a vehicle app included in a head unit of the vehicle and a user terminal app included in a user terminal.

2. The method of claim 1, further comprising determining that the charging state of the battery has entered an unreliable SOC in response to a charge/discharge cycle being repeated ten or more times in succession while the battery is not fully charged.

3. The method of claim 1, further comprising outputting a message informing that a charging target amount setting cannot be changed on both of or one of an output unit included in the head unit and the user terminal app, in response to a user's attempt to change the charging target amount setting being detected, after the deactivating of the charging target amount setting function.

4. The method of claim 1, further comprising reactivating the charging target amount setting function in both of or one of the vehicle app and the user terminal app, in response to the charging state of the battery being not in the unreliable SOC, after the deactivating of the charging target amount setting function.

5. The method of claim 4, further comprising determining that the battery of the vehicle is not in the unreliable SOC in response to the battery of the vehicle being fully charged at least once.

6. The method of claim 1, further comprising, after the monitoring and before entering the unreliable SOC, in response to a charge/discharge cycle being repeated five or more times in succession while the battery is not fully charged, outputting a first preliminary alarm to an output unit included in the vehicle, the user terminal app, or a cluster included in the vehicle, or to any combination thereof.

7. The method of claim 6, further comprising, in response to the charge/discharge cycle being repeated eight or more times in succession while the battery is not fully charged, outputting a second preliminary alarm to the output unit, the user terminal app, or the cluster, or to any combination thereof.

8. The method of claim 1, further comprising, in response to determining that the type of the battery of the vehicle is other than the LFP type, performing a preset function in each of the vehicle app and the user terminal app, respectively, without outputting a separate alarm.

9. A battery charging guidance system comprising:
a battery management unit configured to determine a type of a battery installed in a vehicle and monitor a charging state of the battery; and
a head unit connected to the battery management unit,
wherein the head unit comprises a processor, a communication unit, an output unit, and a vehicle app,
wherein the head unit is configured to communicate with both of or one of a server and a user terminal app using the communication unit, and
wherein, in response to the battery management unit determining that the battery is a lithium iron phosphate (LFP) type and the charging state is in an unreliable state of charge (SOC), the processor is configured to fix a charging target amount of the battery to full charge and deactivate a charging target amount setting function of a user in both of or one of the vehicle app and the user terminal app.

10. The system of claim 9, wherein the battery management unit is configured to determine that the battery has entered the unreliable SOC in response to a charge/discharge cycle being repeated ten or more times in succession while the battery is not fully charged.

11. The system of claim 9, wherein, in response an attempt of the user to change a charging target amount setting being detected after the charging target amount setting function is deactivated, the processor is configured to output a message informing that the charging target amount setting cannot be changed on both of or one of the output unit and the user terminal app.

12. The system of claim 9, wherein the processor is configured to reactivate the charging target amount setting function in both of or one of the vehicle app and the user terminal app in response to the charging state of the battery being not in the unreliable SOC after the charging target amount setting function is deactivated.

13. The system of claim 12, wherein the processor is configured to determine that the battery is not in the unreliable SOC in response to the battery being fully charged at least once.

14. The system of claim 9, wherein the processor is configured to output a first preliminary alarm to the output unit, the user terminal app, a cluster included in the vehicle, or any combination thereof, in response to a charge/discharge cycle being repeated five or more times in succession while the battery is not fully charged.

15. The system of claim 14, wherein the processor is configured to output a second preliminary alarm to the output unit, the user terminal app, the cluster, or any combination thereof, in response to the charge/discharge cycle being repeated eight or more times in succession while the battery is not fully charged.

16. The system of claim 9, wherein the processor is configured to initiate performing of a preset function in each of the vehicle app and the user terminal app, respectively, without outputting a separate alarm, in response to the battery management unit determining that the type of the battery of the vehicle is other than the LFP type.

17. A battery charging guidance method comprising:
determining a type of a battery installed in a vehicle;
monitoring a charging state of the battery;
if the monitoring determines that the battery is not in an unreliable state of charge (SOC), in response to determining that a charge/discharge cycle has repeated a first number of times or more in succession while the battery was not fully charged, outputting a first preliminary alarm to a user;
if the monitoring determines that the battery is not in the unreliable SOC and after the outputting of the first preliminary alarm, in response to determining that the charge/discharge cycle has repeated a second number of times or more in succession while the battery was not fully charged, wherein the second number of times is greater than the first number of times, outputting a second preliminary alarm to the user; and
if the monitoring determines that the battery is in the unreliable SOC, disabling a charging target amount setting function for the user.

18. The method of claim 17, further comprising, if after the disabling the charging target amount setting function for the user, in response to the user attempting to use the charging target amount setting function, outputting a third message to the user.

19. The method of claim 17, further comprising, in response to the battery being fully charged, enabling the charging target amount setting function for the user.

20. The method of claim 17, further comprising, in response to the battery being fully charged, resetting a counter for the charge/discharge cycle.
